(19) United States
(12) Patent Application Publication
(10) Pub. No.: US 2016/0301736 A1
(43) Pub. Date: Oct. 13, 2016

(54) SYSTEMS AND METHODS FOR PROVIDING REMOTE ACCESS TO AN APPLICATION

(71) Applicant: OSIX Corporation, Redwood City, CA (US)

(72) Inventors: Adrian Cesena, JR., Palo Alto, CA (US); Edward Parsons, San Francisco, CA (US)

(21) Appl. No.: 15/093,186

(22) Filed: Apr. 7, 2016

Related U.S. Application Data
(60) Provisional application No. 62/144,820, filed on Apr. 8, 2015.

(51) Int. Cl. H04L 29/08; H04L 29/06; G06F 3/0485

(52) U.S. Cl. CPC H04L 67/025; G06F 3/0485; H04L 67/10; H04L 67/42

(57) ABSTRACT

Requests for content are received by a server from one or more remote devices. The server retrieves the content and renders it in a virtual client. The content is delivered to the one or more remote devices according to one of a plurality of delivery modes according to a detected usage of the content on the one or more remote devices. The delivery mode for the same content may change dynamically in response to changes in usage. The delivery modes may include providing an image of the content, a hybrid of an image with computer code defining operation of one or more interface elements of the content, an image of the content with computer code instructing the retrieval of video content directly from a source, and an image of the content followed by partial updates to the image in response to changes in the content.

### RELATED APPLICATION

This application claims priority to U.S. Provisional Application Ser. No. 62/144,820 filed Apr. 8, 2015, and entitled SYSTEMS AND METHODS FOR PROVIDING REMOTE ACCESS TO AN APPLICATION.

### FIELD OF THE INVENTION

This invention relates to systems and methods for remote access of applications by one or more users.

### BACKGROUND

The Internet has become an essential medium for business and media. As mobile devices become more capable they are frequently use for many internet-based activities. However, many mobile devices still lack the capabilities of a desktop or laptop computer and may also have limited network bandwidth.

The systems and methods disclosed herein provides an improved approach for providing Internet-based functionality on a device with limited processing capabilities or bandwidth.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing methods in accordance with embodiments of the invention;

FIG. 2 is a process flow diagram of a method for performing virtual browsing with multiple delivery modes for use in performing dynamic multi-modal content delivery in accordance with an embodiment of the present invention;

FIG. 3 is a process flow diagram of a method for dynamic multi-modal content delivery in accordance with an embodiment of the present invention;

FIG. 4 is a process flow diagram of a method for performing co-browsing in accordance with an embodiment of the present invention; and

FIG. 5 is a schematic block diagram of an example computing device suitable for implementing methods in accordance with embodiments of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

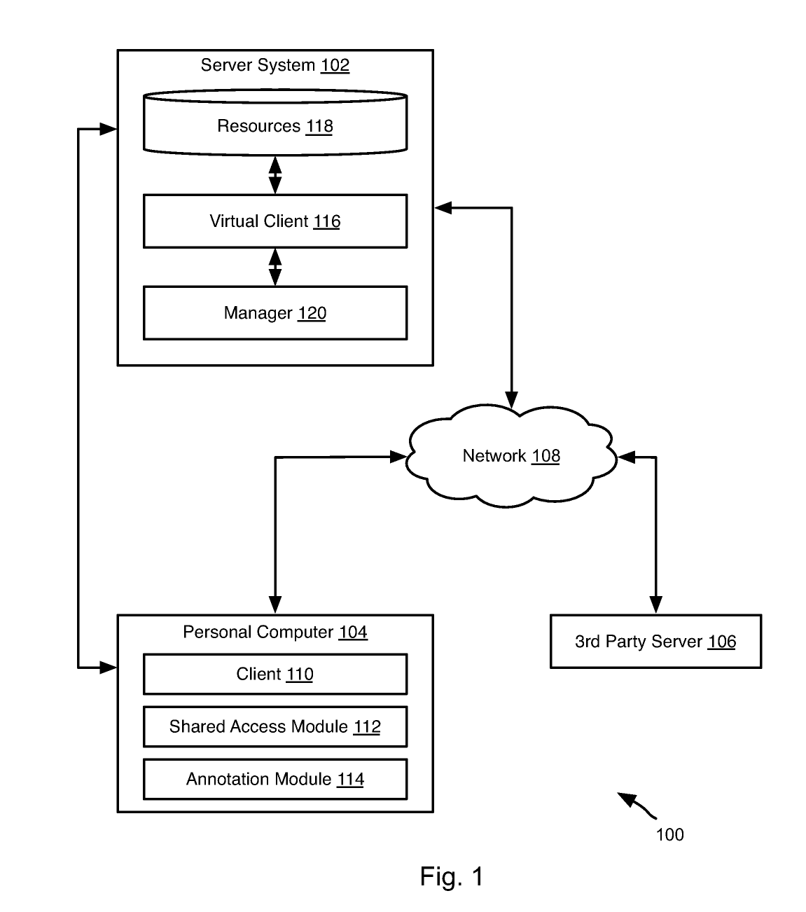

Referring to FIG. 1, a network environment 100 may be used to implement methods as described herein. The environment 100 may include a server system 102 that performs various functions described herein with respect to a personal computer 104 to facilitate access by the personal computer 104 of a third party server 106. Communication among the server system 102, personal computer 104, and third party server 106 may be performed over a network 108 including one or more wired or wireless connections implementing some or all of the Internet, a local area network (LAN), wide area network (WAN), or some other type of network.

The personal computer 104 may host and execute a client 110, which may be a browser or some other type of client application. As known in the art, the client 110 embodied as a browser may request, receive, and render webpages, such as webpages provided by a third party server 106 embodied as a web server. The client 110 may be any type of client application that provides an interface to a remote application executing on a third party server 106.

In some embodiments, the novel functions ascribed herein to the client 110 embodied as a browser may be performed by code embedded in webpages viewed in the browser, a plug in or extension to the browser, or integrated into the browser itself.

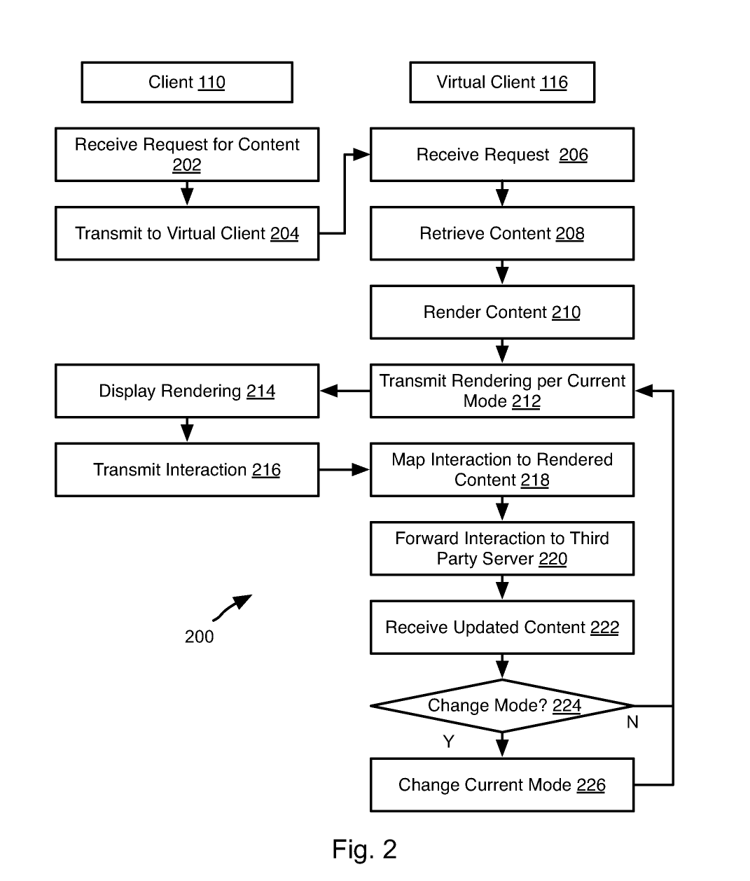

The personal computer 104 may further host and execute a shared access module 112 and annotation module 114, the function of which are described in greater detail below with respect FIGS. 2 through 4.

The server system 102 may provide a virtual client 116, e.g. browser or client for some other type of client application, that retrieves resources 118 from a third party server 106 and performs other functions in order to provide access to the personal computer 104 functionalities and interfaces provided by applications executing on a third party server 106 as described below with respect to FIGS. 2 through 4. The server system 120 may further host and execute a manager 120 that manages connections to the personal computer 104 and manages delivery of content from the third party server 106 to the personal computer 104 according to the capacity of the personal computer 104 and the network connection between the server system 102 and personal computer 104 as determined by the manager 120.

Referring to FIG. 2, the illustrated method 200 may be used to provide access to an application executing on a third party server 106. In one example, the client 110 is a web browser and the application executing on a third party server is a web server. In other embodiments, the client 110 is a client application programmed to interface with the virtual client 110 according to the methods described herein.

The client 110 of the personal computer 104 may receive 202 a request for content. Where the client 110 is a browser, the request for content may be selection of a link to content in a webpage that references a URL or input of a URL into a browser, or some other input that invokes a request for content by a the browser. Where the client 110 is some other type of client application for interfacing with the virtual client 116, a request for content may be an actual request for content, e.g. request including a name of a file or item of data. The request for content may be any interaction with an interface presented by the client 110 that will invoke updating of the interface using information from the server application on the third party server 106.

In some embodiments, the interface presented on the personal computer 104 is an image or video feed of an interface such that actual interface elements are not defined on the personal computer 104. Accordingly, receiving 202 the request for content may include receiving a selection (click, tap, etc.) or input of text that does not of itself reference the content, but is mapped to interface elements invoking requests for the content by the virtual client 116 inasmuch as the virtual client 116 includes a virtual interface that includes the interface elements of a webpage or interface to some other type of application.

The request received 202 may be transmitted 204 to the virtual client 116. The virtual client receives 206 the request and retrieves 208 the requested content from the third party server 106. Where the request is URL, this may include retrieving a webpage referenced by the URL from a web server on the third party server 106. Retrieving 208 the content may further include retrieving one or more other resources referenced by the webpage referenced by the URL, such as images, GIFs, video feeds, text files, or other content files.

Where the interface presented on the client 110 is an image or video feed of the webpage or other interface, the virtual client may receive coordinates and/or text of inputs received at step 202 and map these to an interface element in the web page or interface rendered by the virtual client 116. The virtual client 116 may then retrieve the content 208 referenced by the interface element to which the inputs of step 202 correspond from the web server or other application hosted by the third party server 106.

The content retrieved 208 may be rendered 210 by the virtual client. For example, the content may be in the form of executable code (e.g. HTML, XML, JavaScript, etc.) and content files that must be interpreted in order to obtain an image of the interface encoded thereby. Accordingly, the virtual client 116 processes the content in order to obtain an image of the interface defined by the content.

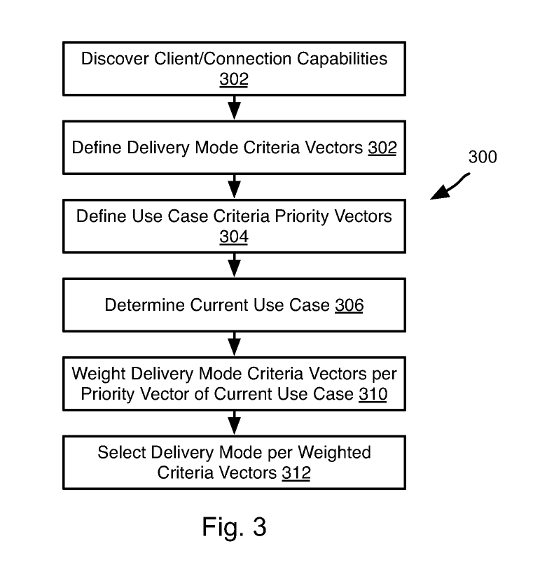

The rendering may then be transmitted 212 to the client 210 according to a current delivery mode. As noted above, the interface transmitted to the client 110 may be provided using any of a plurality of delivery modes including as a series of images, a video feed, VNC (virtual network computing) code, HTML code, or a hybrid of some or all of these approaches. The current delivery mode may be selected dynamically using the method described below with respect to FIG. 3.

Upon receiving the rendering, the client 110 displays 214 the rendering on the personal computer 104, e.g. the display device thereof. Interactions with the rendering, e.g. selection of elements, key presses, etc. are received by the client 110 and transmitted 216 to the virtual client. Transmitting 216 the interactions may include transmitting a location within the rendering at which selections occurred alone with any key presses that accompanied it.

Upon receiving the interactions, the virtual client 116 may map the interaction locations to interface elements of the webpage or other interface rendered by the virtual client. The actions invoked by the selected element may be performed, which may include invoking a message that will cause updating of the webpage or interface of the virtual client. Accordingly, messages to the web server or other application executing on the third party server 106 that are invoked in response to the interaction by executable code defining the interface element may be forwarded 220 to the third party server. The web server or other application may then provide updated content, e.g. an updated interface or other webpage, which it then returns to the virtual client 116. The virtual client 116 receives the updated content 222.

In some embodiments, interactions received at step 218 and/or content received 222 in response to interactions may invoke a change in delivery mode as described below with respect to FIG. 3. If a change in mode is found 224 to be required, then the current delivery mode is changes 226 to a new delivery mode, and the method 200 continues at step 212 with the updated content being transmitted according to the current delivery mode as changed at step 226.

Referring to FIG. 3, the illustrated method 300 may be executed by the manager 120 in order to perform dynamic multi-modal content delivery, such as in the context of steps 224 and 226 of the method 200 of FIG. 2. In particular, the content rendered in a virtual client 116 may be provided to a client 110 by various modes depending on a current use case. The mode selected may be varied dynamically in response to user inputs and the content being accessed. The mode of delivery may be altered with respect to the same interface or content from moment to moment depending on the content and user actions performed with respect to the webpage or interface.

The method 300 may include discovering 302 the capabilities of one or both of the personal computer 104, the client 110, and the network connection between the server 102 and the personal computer 104. This may include determining the bandwidth of the network connection, processing speed of the CPU of the personal computer 104, available APIs (application programming interface), screen size, type of device (laptop or desktop computer, smart phone, tablet computer, etc.), operating system, a user's current type or manner of use of the content, the type of content being requested, available memory, and like parameters.

The method 300 may further include defining 302 or retrieving delivery mode criteria vectors for a plurality of delivery modes. Examples of delivery modes may include:
Delivery of snapshots of a rendered interface, such as in a compressed image format
Delivery of a video of the interface at a given frame rate, such as in a compressed video format such as MPEG4.
Delivery of a rendering of the interface using Virtual Network Computing (VNC) code.
Delivery of a rendering of the interface as a hybrid of any of the preceding delivery modes.
Delivery of partial updates to an image of the interface, e.g. just portions of the interface that are added and removed due to scrolling. Partial updates may be sent at higher frequency than snapshots or video of the interface.
Delivery of an instruction set to recreate content based on source API availability on the recipient computer.

The criteria vector for a delivery mode may include values for a plurality of criteria indicating how well that delivery mode meets each criteria. For example, criteria may include speed of first frame update, speed of component update, API availability, and required bandwidth. For each of these criteria, the criteria vector for a delivery mode may include values indicating the strengths of that delivery mode with respect to that criteria.

The method 200 may further include defining use case criteria priority vectors 304. The criteria priority vector for each use case may indicate the priority of each criteria when that use case is applicable. Specifically, the criteria priority vector indicates how critical it is that the selected delivery mode have a high strength in that area. Examples of use cases include, (a) where a detected user interaction is selection of a form field or providing keystrokes for inputting text to a form field, (b) loading of a webpage or interface, e.g. the first time a webpage or interface is loaded, (c) scrolling through a webpage or other interface, (d) loading or updating of a webpage or other interface that includes video, (e) the personal computer 104 is a mobile device.

The steps 302-304 may be performed periodically, but less frequently than the frequency of updates to the webpage or interface, e.g. less frequently than the use case of the virtual client 116 and client 110 changes. Some or all of steps 306-312 may be performed in response to changes in the use case of the virtual client 116 and client 110, e.g. every change in use case or every N change in use case, where N is a value greater than one.

The method 300 may include determining 306 a change in use case to become a current use case, weighting 310 the criteria vectors of the delivery modes according to the priorities for the criteria in the priority vector of the current use case, and selecting 312 one of the delivery modes according to the weighted criteria vectors.

For example, in response to occurrence of a given use case, the criteria vector of the delivery mode may be weighted according to the criteria priority. The weighted values of the criteria vector for each delivery mode may then be summed to obtain a score for that delivery mode. The delivery mode with the highest score may then be selected as the current delivery mode. State differently, Cᵢ may be a vector of strengths of a delivery method (i) for a plurality of criteria and Pⱼ may be a vector of the priorities of the plurality of criteria for a particular use case (j). Scores Mᵢⱼ=Cᵢ·Pⱼ may be calculated, i.e. the dot product Cᵢ·Pⱼ. The delivery mode (j) with the highest score Mᵢⱼ may then be selected as the delivery mode for that use case (i). In some embodiments, the delivery modes may be ranked according to the scores Mᵢⱼ and the delivery mode (j) having the highest score Mᵢⱼ and that is supported by the personal computer 104 is selected as the current delivery mode for the current use case (i). For example, the delivery modes supported by a personal computer 104 that is the subject of the method 300 may be determined from the capabilities discovered at step 302. For example, APIs required by a particular delivery mode may be determined to be or to not be present. The bandwidth available may be determined in order to determine whether its meets the required bandwidth of a particular delivery mode. Any operating system version, memory, software modules, processing power, or other capability of the personal computer that may be required to execute a delivery mode may be discovered 302 and used to determine which delivery modes are available. From among those delivery modes that can be executed on the personal computer 104 according to the capabilities of the personal computer 104, the one with the highest score Mᵢⱼ may then be selected as the current delivery mode.

For example, in response to a change in the current use case from another use case, a method may include (a) selecting as a potential delivery mode the highest ranked delivery mode for the current use case (e.g. highest score Mᵢⱼ as discussed above); (b) if the potential delivery mode is supported by the personal computer 104, it is made the current delivery mode; (c) if the potential delivery mode is not supported, and there is any next-highest-ranked delivery mode, then the next highest-ranked delivery mode is set to be the potential delivery mode and (a)-(c) are repeated; and (d) if there are no other lower-ranked delivery modes that are supported, then the current delivery mode will not be changed in response to a change to the current use case from another use case.

In some embodiments the matrix of scores Mᵢⱼ may be pre-calculated such that step 310 may be omitted from being performed after each change, or each N changes, in the use case. Instead, the values Mᵢⱼ for the current use case j may be retrieved and the delivery mode (i) with the highest value Mᵢⱼ may then be selected as the current delivery mode.

In one example scenario, a user requests a webpage and is sent an image of the rendered web page. The user selects a fillable field, e.g. text input field, and, in response, the user is sent a snapshot of the webpage with the selected fillable field superimposed as an interactive VNC or HTML element. The user scrolls through the webpage and is sent partial updates in order to increase the speed at which the webpage is updated (e.g. when the user moves the page up, portions of the page that appear at the bottom will be sent rather than the entire visible portion). If the page includes video and the user requests to view the video, a snapshot of the page may be sent with instructions for the client 110 to retrieve the video from a source of the video using an API available to the client 110. The video, once retrieved, may then be superimposed by the client 110 on the snapshot of the page. Table 1 summarizes user actions, the current use case determined to be in use for that user action, and the delivery mode that will be selected as the current delivery mode if it is available for that use case. Table 2 summarizes an example of scores for various delivery modes for example uses cases and the ranking that may be performed based thereon.

TABLE 1
Delivery modes and use cases for user actions.

| User Action | Use Case | Delivery Mode |
|---|---|---|
| A user makes initial visit | Initial page load | Snapshot of rendered |
| to website | | webpage |
| User clicks on text input | Component | Hybrid snapshot and VNC |
| field (e.g. search box) | Update | code for text input field |
| User inputs text to text | Component | Hybrid snapshot and VNC |
| input field | Update | for text input field (render |
| | | text input locally using |
| | | VNC code) |
| User clicks on link to | Initial page load | Snapshot of rendered |
| video | | webpage for link |
| User invokes playing or | Playing video on | Send instruction set to |
| video commences | page | embed video on personal |
| playing | | computer 104 and retrieve |
| | | video directly form source |
| User invokes playing or | Playing video on | Send video representation |
| video commences | page API for | of rendered webpage |
| playing | local video | |
| | retrieval not | |
| | supported | |
| User scrolls webpage | Scrolling page | Send fast refreshing image |
| | | representation (send only |
| | | added portions of rendered |
| | | web page to personal |
| | | computer 104) |

Table 2 illustrates example priority vectors and criteria vectors

Use Case: Play Video on Page
Priority Vector (P): [speed of first frame update,
speed of component update, API
available, bandwidth necessary]
Criteria Vector (C): [speed of first frame update,
speed of component update, API
available, bandwidth necessary]

| | |
|---|---|
| Delivery Mode: Video | C(dot)P = [8] |
| Feed | |
| Delivery Mode: VNC | C(dot)P = [7] |
| Delivery Mode: | C(dot)P = [6] |
| Snapshot | |
| Delivery Mode: API | C(dot)P = [9] |
| (e.g. local video) | |
| Ranking: | [API, Video, VNC, Snapshot] |

Use Case: Scrolling page

| | |
|---|---|
| Delivery Mode: Video | C(dot)P = [8] |
| Feed | |
| Delivery Mode: VNC | C(dot)P = [5] |
| Delivery Mode: API | C(dot)P = [0] |
| (e.g. local video) | |
| Delivery Mode: Partial | C(dot)P = [9] |
| Updates | |
| Ranking: | [Partial Updates, Video Feed, |
| | VNC, API] |

An example of an approach for dealing with display of video using a virtual client 116 is described in U.S. Provisional Application Ser. No. 62/055,507 filed Sept. 25, 2014, and entitled “Computer-Implemented Methods, Computer Readable Media, and Systems For Distributed Processing” and U.S. Provisional Application Ser. No. 62/063,668 filed Oct. 14, 2014, and entitled “Computer-Implemented Methods, Computer Readable Media, and Systems For Distributed Processing,” which are hereby incorporated herein by reference in their entirety. Likewise, the systems and methods disclosed herein may be used in an application enabling co-editing of a document by multiple users as disclosed in U.S. Provisional Application Ser. No. 62/055,523 filed Sep. 25, 2014, and entitled “Computer-Implemented Methods, Computer Readable Media, and Systems For Co-Editing Content” and U.S. Provisional Application Ser. No. 62/063,668 filed Oct. 14, 2014, and entitled “Computer-Implemented Methods, Computer Readable Media, and Systems For Co-Editing Content,” which are hereby incorporated herein by reference in their entirety. The systems and methods disclosed herein for accessing an application by multiple users by means of a virtual client may be performed in combination with the methods for initiating co-use of application disclosed in U.S. Provisional Application Ser. No. 62/002,423 filed May 23, 2014 and entitled “Computer Implemented Methods, Computer Readable Media, and Systems for Initiating Co-use of Applications,” which is hereby incorporated herein by reference in its entirety.

In previous approaches to delivery of content and associated co-browsing/co-sharing of web and apps, the delivery of content is delayed, degraded, slowed or lost due to a variety of issues inherent in the current content delivery technologies, device platforms, network architecture/function/protocols and similar factors. The dynamic multi-modal delivery approach described herein advantageously solves these problem by breaking up delivery of content into components that can be delivered in different ways and then selecting the appropriate delivery for one or more components depending on the use case (as described above with respect to FIG. 3). The algorithm of FIG. 3 may be used to select an appropriate combination of modalities for each component such that, overall, the delivery of the content is performed quickly and most reliably.

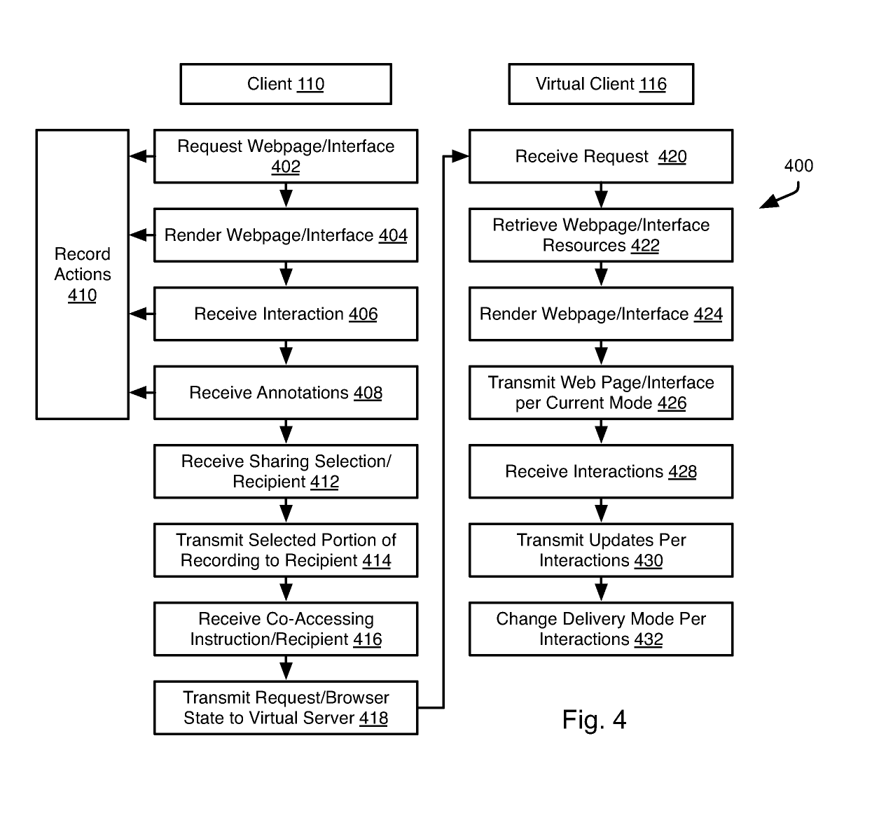

Referring to FIG. 4, the illustrated method 400 may be performed by the client 110 executing on the personal computer 104 and virtual client 116 on a server 102. The method 400 may include performing by the client 110 (e.g. a browser), in no particular, order browsing activities, such as requesting 402 one or more webpages; rendering 404 the one or more webpages on a display device, receiving 406 interactions such as selection of links, inputting of text into forms, uploading data, or other interactions with user interface elements on the one or more webpages. Likewise, the method 400 may be performed by the client 110 with respect to a remote application with an interface to the remote application being provided on the personal computer 104 executing the client 110. Corresponding actions to the interactions may be performed, such as updating the webpage or other interface, requesting a new webpage or interface, or other actions known in the art that may be invoked in response to user interaction with a webpage or interface to a remote application. The method 400 may further include receiving 408 annotations from the user. Annotations may include instructions to superimpose text or drawings over a currently displayed webpage or interface, recording of audio and video during display of a webpage, superimposing of photos on a currently displayed webpage or interface, or any other textual, visual, audio, or video inputs.

The activities of steps 402-408 may be recorded 410. In particular, both the actions and timing of actions may be recorded such that they may be performed in the same order. For example, the display of webpages or interfaces and selection of links and/or interface elements may be replayed along with audio and video recorded as these acts were being performed. In many cases, the same page may be viewed repeatedly or for a period of time in which no actions are received (e.g. steps 406-408) in order to avoid recording information that is not changing, the step of recording actions 410 may pause or exclude repetitious actions or periods of times during recording in which no actions are received.

In addition to recording 410 identifiers of webpages or interfaces that are requested, metadata that was originally in the source (webpage or interface) being recorded may also be stored so as to augment the recording by adding functionality available to the original page. For example, links, images, and other data used to render a webpage or other interface.

The method 400 may further include receiving 412 a selection of a portion of recorded actions and an instruction to share the selected portion of the recorded actions with a recipient. For example, a user may select a time range or beginning and ending actions such that all acts within the time range or occurring between the beginning and ending actions are determined to be the actions to be shared.

The client 110 may transmit 412 the selected portion of the recorded actions to the recipient, such as by means of email, instant messenger, or by means of the server system 102 through an application specific messaging platform. Transmitting 412 the selection may include transmitting the recorded actions as recorded or through references to the selected actions. For example, where a recorded action is requesting a webpage, the URL may be transmitted 412 rather than the webpage itself. Likewise, where a recorded act is a selection of a link in a webpage, an identifier of the link may be sent. Where the actions are performed with respect to an interface, a reference to the interface and the data represented therein may be transmitted. Actions taken with respect to interface elements may include a description of acts taken (click, hover, double click, etc.) as well as an identifier of the interface element.

Upon receiving the recording, a recipient computing device may then play back the acts recorded in the selected portion thereby displaying the same webpages, selection of links, placing of annotations, playback of recorded video or audio, in order to recreate the recorded portion of the browsing session on the recipient computer. Where the recording is of interactions is performed with respect to an application, playing back of the recording may include retrieving interfaces referenced, performing actions with respect to the interfaces referenced, as well as playing back any annotations and recorded video and audio in synchronization with display of the interface and re-performing actions performed with respect thereto in the manner recorded.

The method 400 may further include initiating a co-accessing session with one or more other users, such as the recipient of steps 412-414 or some other individual and corresponding computing device.

For example, the method 400 may include receiving 416 an instruction to initiate a co-accessing session and an identifier of the recipient, such as in the form of a username, device identifier, or other identifying information. In response to the instruction, the client 110 (e.g. browser) may transmit the instruction received at step 416 with the browser or interface state to the virtual client 116 (e.g. virtual browser). Transmitting 418 the browser state may include transmitting the recorded 410 actions for the browsing session or just those acts required to replicate the currently view in the client 110, e.g. the current webpage or interface and any scrolling, inputs, or other actions that would alter the display of the current webpage or interface.

The virtual client 116 may receive 420 the request transmitted at step 418 and retrieve the webpage or interface resources 422 of the webpage or interface referenced in the request, e.g. the webpage or interface itself as well as resources referenced by the webpage or interface (images, video, GIFs, and other content) and rendering 424 the webpage or interface. Rendering 424 the webpage or interface may include performing transformations indicated by the transmitted browser or interface state in order to replicate the view of the webpage or interface by the client 110 at the time of receiving 416 the instruction to initiate a co-accessing session. In some embodiment, a recording may include metadata for a webpage or interface (links, images, other data) such that this data may be used to render the webpage in order to recreate the webpage or interface as it was viewed by the person that is sharing the recording.

The webpage or interface as rendered 424 may then be transmitted 426 to the recipient computer, which may be embodied as a personal computer, and the invitee computer, i.e. the personal computer 104 executing the client 110. The method 400 may further include receiving 428 interactions from the invitee and recipient computers, transmitting 430 updates to the recipient and invitee computers, and changing 432 the delivery modes to one or both of the invitee and recipient computers in the manner described above with respect to FIG. 3.

Where virtual accessing is being performed through the virtual client 116, various actions may be taken with respect to video data included in the webpage or interface rendered in the virtual client 116. For example, where the video data is not longer viewable by any of the users, display thereof may be ceased, i.e. it will no longer be transmitted to the users. If one of the personal computers connected to the virtual client 116 in a co-accessing session is detected to have a slower network connection, display of video for other users in co-accessing arrangement may be delayed such that viewing of the video is synchronized. Likewise, during periods where a user is not interacting with a video (annotating, selecting, or the like) buffers storing the video may be further filled with video data. In some embodiments, a real time feed of video is provided that is live transcoded to be playable on any of the personal computers 104 participating in the co-accessing of the webpage or interface.

Although the method 400 of FIG. 4 discloses the sharing of recordings and co-accessing content between and a user and an invitee, the method 400 may be expanded to include the broadcasting of a recording or an invitation to perform co-accessing to multiple users or the public at large.

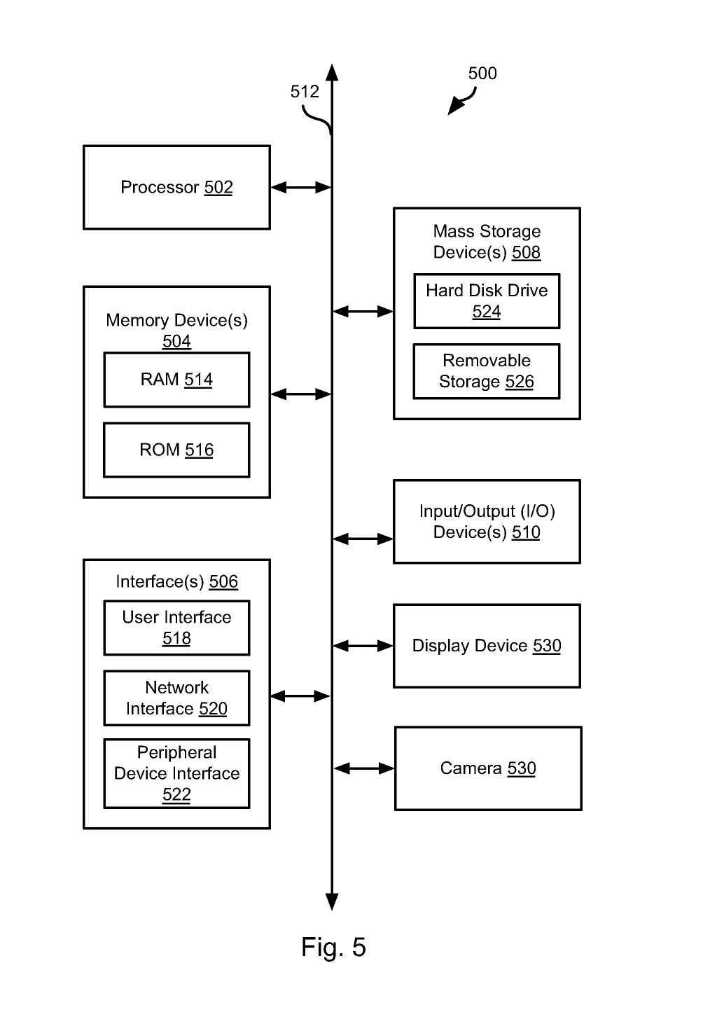

FIG. 5 is a block diagram illustrating an example computing device 500. Computing device 500 may be used to perform various procedures, such as those discussed herein. A server system 102, personal computer 104, and third party server 106 may have some or all of the attributes of the computing device 500. Computing device 500 can function as a server, a client, or any other computing entity. Computing device can perform various monitoring functions as discussed herein, and can execute one or more application programs, such as the application programs described herein. Computing device 500 can be any of a wide variety of computing devices, such as a desktop computer, a notebook computer, a server computer, a handheld computer, smartphone, mobile computing device, tablet computer, and the like. In particular, the personal computer 104 may be embodied as any of these devices and a user may have multiple of such computing devices associated therewith and performing the functions of the personal computer 104 with respect to that user. A server system 102a-102c may include one or more computing devices 500 each including one or more processors.

Computing device 500 includes one or more processor(s) 502, one or more memory device(s) 504, one or more interface(s) 506, one or more mass storage device(s) 508, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, etc.), keyboards, and the like.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

The present invention may be embodied in other specific forms without departing from its spirit or essential characteristics. The described embodiments are to be considered in all respects only as illustrative, and not restrictive.

What is claimed is:

1. A method comprising:
receiving, by a server system, a request for a first content, from a first remote computing device;
rendering, by the server system, the first content within a virtual client;
transmitting, by the server system to the first remote computing device, a first representation of the first content according to a first delivery mode;
detecting, by the server system, a first usage mode of the first rendering of the first content on the first remote computing device; and
in response to detecting the first usage mode of the first rendering of the first content on the first remote computing device, transmitting, by the server system, a second representation of the first content according to a second delivery mode.

2. The method of claim 1, wherein the first delivery mode is an image of a rendering of the first content.

3. The method of claim 2, wherein:
the first usage mode is interaction with a fillable form element; and
the second delivery mode is delivery of a hybrid rendering including the image of the rendering of the first content in combination with executable code defining operation of the fillable form element.

4. The method of claim 2, wherein:
the first usage mode is interaction with a link to video content; and
the second delivery mode is delivery of a hybrid rendering including the image of the rendering of the first content in combination with executable code instructing retrieval of the video content from a source of the video content and rendering of the video content on the first remote computing device.

5. The method of claim 2, wherein:
the first usage mode is scrolling of the first representation of the first content; and
the second delivery mode is delivery of partial updates to the image of the rendering of the first content to the first remote computing device in response to the scrolling of the first representation.

6. The method of claim 1, further comprising:
storing, by the server system, a plurality of criteria vectors, each criteria vector corresponding to a delivery mode of a plurality of delivery modes, the plurality of delivery modes including the first delivery mode and the second delivery mode;
storing, by the server system, a plurality of priority vector, each priority vector corresponding to a different usage mode of a plurality of usage modes, the plurality of usage modes including the first usage mode;
in response to detecting the first usage mode of the first rendering of the first content on the first remote computing device
evaluating, by the server system, a plurality of scores, each score of the plurality of scores being a dot product of one of the criteria vectors of the plurality of criteria vectors and the priority vector of the plurality of priority vectors corresponding to the first usage mode;
selecting, by the server system, the second delivery mode in response to determining that the score of the plurality of scores corresponding to the dot product of the criteria vector corresponding to the second delivery mode and the priority vector corresponding to the first usage mode is higher than one or more other scores of the plurality of scores.

7. The method of claim 6, further comprising:
receiving, by the server system, a description of the first remote computing device;
wherein selecting the second delivery mode comprises selecting the second delivery mode in response to determining that the second delivery mode is supported by the first computing device based on the description of the first remote computing device and in response to determining that the score of the plurality of scores corresponding to the dot product of the criteria vector corresponding to the second delivery mode and the priority vector corresponding to the first usage mode is higher than one or more other scores of the plurality of scores.

8. The method of claim 6, wherein the criteria vector includes values corresponding to a speed of a first frame update, a speed of component updates, application programming interface (API) availability, and a bandwidth requirement.

9. The method of claim 1, wherein the first remote computing device is a mobile computing device.

10. The method of claim 1, further comprising:
transmitting, by the server system to a second remote computing device, a first representation of the first content according to a first delivery mode;
detecting, by the server system, a second usage mode of the first rendering of the first content on the second remote computing device, the second usage mode being different from the first usage mode; and
in response to detecting the first usage mode of the first rendering of the first content on the first remote computing device, transmitting, by the server system, a third representation of the first content according to a third delivery mode.

11. A system comprising one or more processors and one or more memory devices operably coupled to the one or more memory devices, the one or more memory device storing executable code effective to cause the one or more processors to:
receive a request for a first content, from a first remote computing device;
render the first content within a virtual client;
transmit to the first remote computing device, a first representation of the first content according to a first delivery mode; and
if a first usage mode of the first rendering of the first content on the first remote computing device is detected, transmit a second representation of the first content to the first remote computing device according to a second delivery mode

12. The system of claim 11, wherein the first delivery mode is an image of a rendering of the first content.

13. The system of claim 12, wherein:
the first usage mode is interaction with a fillable form element; and
the second delivery mode is delivery of a hybrid rendering including the image of the rendering of the first content in combination with executable code defining operation of the fillable form element.

14. The system of claim 12, wherein:
the first usage mode is interaction with a link to video content; and
the second delivery mode is delivery of a hybrid rendering including the image of the rendering of the first content in combination with executable code instructing retrieval of the video content from a source of the video content and rendering of the video content on the first remote computing device.

15. The system of claim 12, wherein:
the first usage mode is scrolling of the first representation of the first content; and
the second delivery mode is delivery of partial updates to the image of the rendering of the first content to the first remote computing device in response to the scrolling of the first representation.

16. The system of claim 11, wherein the executable code is further effective to cause the one or more processors to:
store a plurality of criteria vectors, each criteria vector corresponding to a delivery mode of a plurality of delivery modes, the plurality of delivery modes including the first delivery mode and the second delivery mode;
store a plurality of priority vector, each priority vector corresponding to a different usage mode of a plurality of usage modes, the plurality of usage modes including the first usage mode;
in response to detecting the first usage mode of the first rendering of the first content on the first remote computing device—
evaluate a plurality of scores, each score of the plurality of scores being a dot product of one of the criteria vectors of the plurality of criteria vectors and the priority vector of the plurality of priority vectors corresponding to the first usage mode;
select the second delivery mode in response to determining that the score of the plurality of scores corresponding to the dot product of the criteria vector corresponding to the second delivery mode and the priority vector corresponding to the first usage mode is higher than one or more other scores of the plurality of scores.

17. The system of claim 16, wherein the executable code is further effective to cause the one or more processors to:
receive a description of the first remote computing device;
select the second delivery mode in response to determining that the second delivery mode is supported by the first computing device based on the description of the first remote computing device and in response to determining that the score of the plurality of scores corresponding to the dot product of the criteria vector corresponding to the second delivery mode and the priority vector corresponding to the first usage mode is higher than one or more other scores of the plurality of scores.

18. The system of claim 16, wherein the criteria vector includes values corresponding to a speed of a first frame update, a speed of component updates, application programming interface (API) availability, and a bandwidth requirement.

19. The system of claim 11, wherein the first remote computing device is a mobile computing device.

20. The system of claim 11, wherein the executable code is further effective to cause the one or more processors to:
transmit, to a second remote computing device, a first representation of the first content according to a first delivery mode;
detect a second usage mode of the first rendering of the first content on the second remote computing device, the second usage mode being different from the first usage mode; and
in response to detecting the first usage mode of the first rendering of the first content on the first remote computing device, transmit a third representation of the first content according to a third delivery mode.
